(19) United States
(12) Patent Application Publication
(10) Pub. No.: US 2010/0034399 A1
(43) Pub. Date: Feb. 11, 2010

(54) MOUNTING DEVICE FOR MOUNTING A SOUND PICKUP DEVICE ON A SOUND SOURCE

(76) Inventor: Kun-Tien Chiang, Rende Township (TW)

Correspondence Address: OCCHIUTI ROHLICEK & TSAO, LLP, 10 FAWCETT STREET, CAMBRIDGE, MA, 02138, US

(21) Appl. No.: 12/186,617

(22) Filed: Aug. 6, 2008

(51) Int. Cl. H04R 1/02

(52) U.S. Cl. 381/91

(57) ABSTRACT

A mounting device is adapted for mounting a sound pickup device on a surface of a sound source, and includes a base member and a fastening unit. The base member is adapted to be connected to the sound pickup device. The fastening unit is adapted to be provided between the base member and the surface of the sound source for positioning the base member on the surface of the sound source.

### BACKGROUND OF THE INVENTION

1. Field of the Invention

This invention relates to a mounting device, more particularly to a mounting device for mounting a sound pickup device on a sound source.

2. Description of the Related Art

Referring to FIGS. 1 and 2, a conventional sound pickup apparatus 1 is provided on a sound source 3 such as a musical instrument (see FIG. 2), and includes a clamping device 11 for clamping the sound source 3, and a sound pickup device 12 connected to the clamping device 11. When the sound source 3 is clamped by the clamping device 11, the sound pickup device 12 is able to receive sound from the sound source 3 and convert the same into an audio signal. Subsequently, the audio signal is wirelessly transmitted to a remote audio amplifier for processing.

Because the sound pickup apparatus 1 is provided on the sound source 3 via clamping action of the clamping device 11, the sound pickup apparatus 1 is suitable for application to a sound source 3 having a rectangular portion that can be clamped by the clamping device 11. More particularly, the portion of the sound source 3 that can be clamped by the clamping device 11 has to include at least a pair of nearly parallel sides. If the portion of the sound source 3, where mounting of the sound pickup device 12 is desired, is a corner of the sound source 3 or is a curved surface, the clamping device 11 is unable to retain the sound pickup device 12 on such a portion of the sound source 3. Therefore, the utility of the conventional sound pickup apparatus 1 is limited by the clamping device 11.

### SUMMARY OF THE INVENTION

The object of the present invention is to provide a mounting device that is suitable for mounting a sound pickup device on a sound source and that can overcome the aforesaid drawback of the prior art.

According to this invention, a mounting device is adapted for mounting a sound pickup device on a surface of a sound source, and includes a base member and a fastening unit. The base member is adapted to be connected to the sound pickup device. The fastening unit is adapted to be provided between the base member and the surface of the sound source for positioning the base member on the surface of the sound source.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view of a conventional sound pickup apparatus;

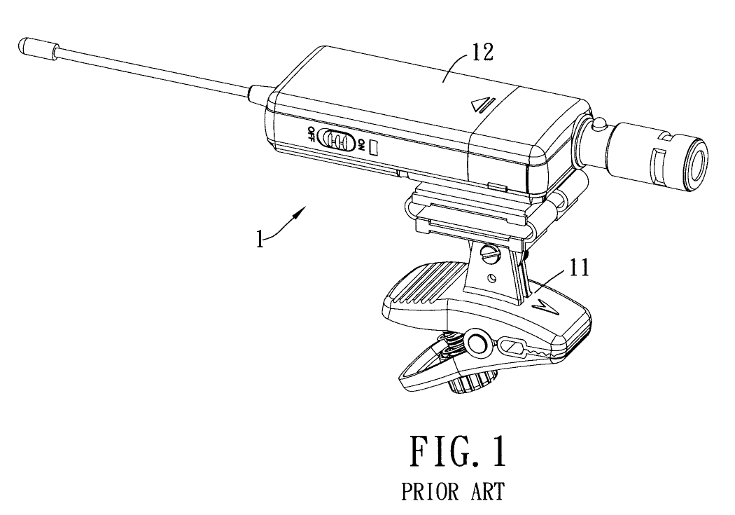

FIG. 2 is a side view illustrating the conventional sound pickup apparatus in a state of use;

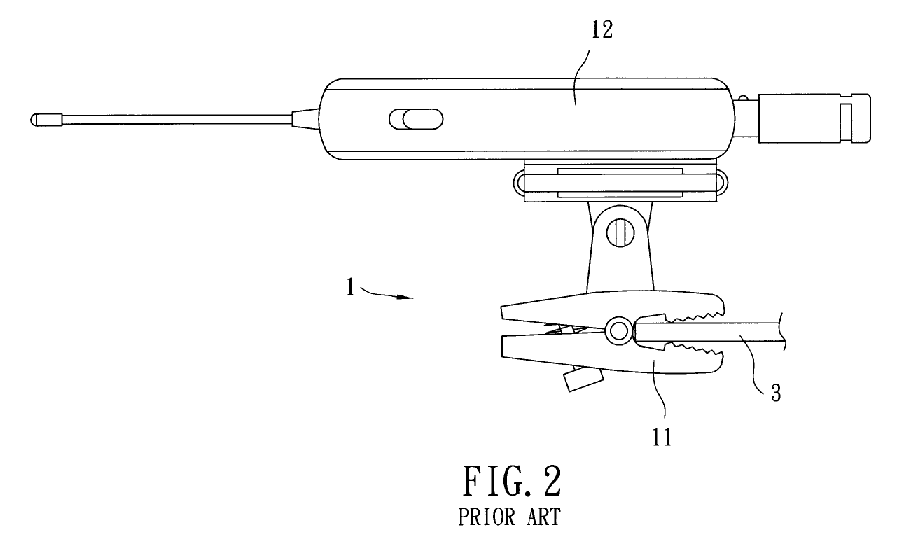

FIG. 3 is a perspective view of the preferred embodiment of a mounting device for mounting a sound pickup device on a sound source according to this invention;

FIG. 4 is a fragmentary schematic side view to illustrate the preferred embodiment in a state of use;

FIG. 5 is a fragmentary schematic side view to illustrate the preferred embodiment in another state of use;

FIG. 6 is a fragmentary schematic side view to illustrate the preferred embodiment in yet another state of use; and

FIG. 7 is a fragmentary schematic side view to illustrate the preferred embodiment in still another state of use.

### DETAILED DESCRIPTION OF THE PREFERRED EMBODIMENT

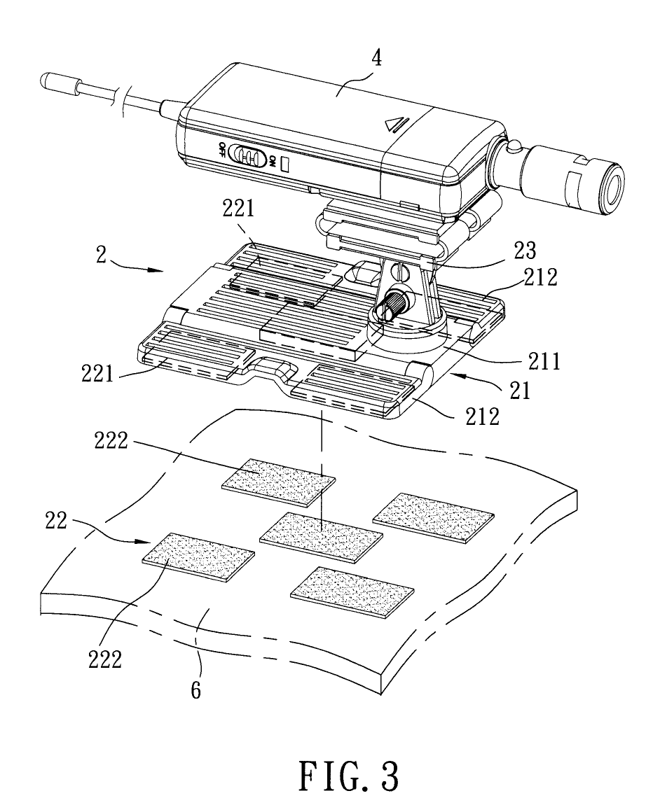

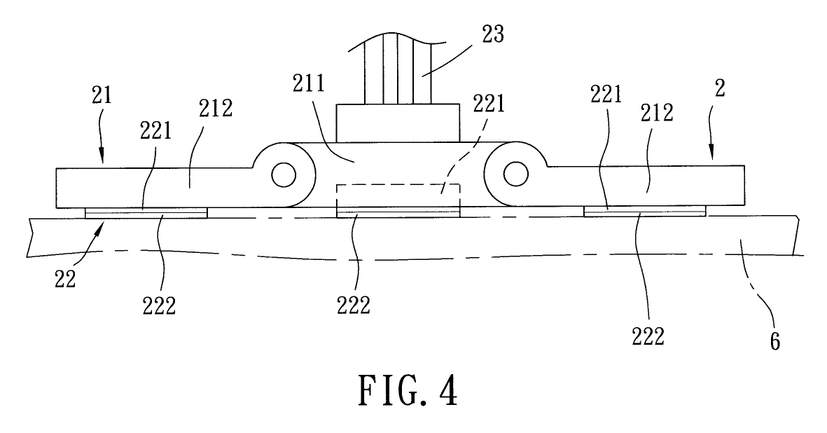

Referring to FIGS. 3 and 4, the preferred embodiment of a mounting device 2 according to the present invention is adapted for mounting a sound pickup device 4 on a surface of a sound source 6 such as a musical instrument, for example, a guitar, a violin, etc. Since the feature of the invention does not reside in the sound pickup device 4, which is known in the art, further details of the same are omitted herein for the sake of brevity. The mounting device 2 includes a base member 21 and a fastening unit 22.

The base member 21 is adapted to be connected to the sound pickup device 4, and includes a main plate body 211 having at least one plate connecting edge, and at least one wing plate body 212 connected pivotally to the plate connecting edge of the main plate body 211.

In this embodiment, the main plate body 211 has two of the plate connecting edges, and the base member 21 includes two of the wing plate bodies 212. Each of the wing plate bodies 212 is connected pivotally to a respective one of the plate connecting edges of the main plate body 211. The plate connecting edges of the main plate body 211 are opposite to each other.

The fastening unit 22 includes at least one first fastening component 221 provided on a surface of the base member 21, and at least one second fastening component 222 adapted to be provided on the surface of the sound source 6 for engaging the first fastening component 221.

Preferably, the fastening unit 22 includes at least one first fastening component 221 provided on the surface of at least one of the main plate body 211 and the wing plate bodies 212 of the base member 21, and at least one second fastening component 222 adapted to be provided on the surface of the sound source 6 for engaging the first fastening component 221.

In this embodiment, the fastening unit 22 includes five of the first fastening components 221 and five of the second fastening components 222. Two of the first fastening components 221 are provided on the surface of one of the wing plate bodies 212, and two other ones of the first fastening components 221 are provided on the surface of the other one of the wing plate bodies 212. The remaining one of the first fastening components 221 is provided on the surface of the main plate body 211. The second fastening components 222 are adapted to be provided on the surface of the sound source 6 for engaging the first fastening components 221, respectively. Each of the first fastening components 221 is a hook fastening component, and each of the second fastening components 222 is a loop fastening component. It is noted that each of the first fastening components 221 may be a loop fastening component, and each of the second fastening components 222 may be a hook fastening component in other embodiments of the invention.

The mounting device 2 further includes a support member 23 that is disposed on the main plate body 211 of the base member 21, and that has one end opposite to the main plate body 211 and adapted to be mounted with the sound pickup device 4. Preferably, the support member 23 is generally T-shaped.

When the base member 21 of the mounting device 2 is attached to a flat surface of the sound source 6, the base member 21 has a flat shape corresponding to the flat surface of the sound source 6.

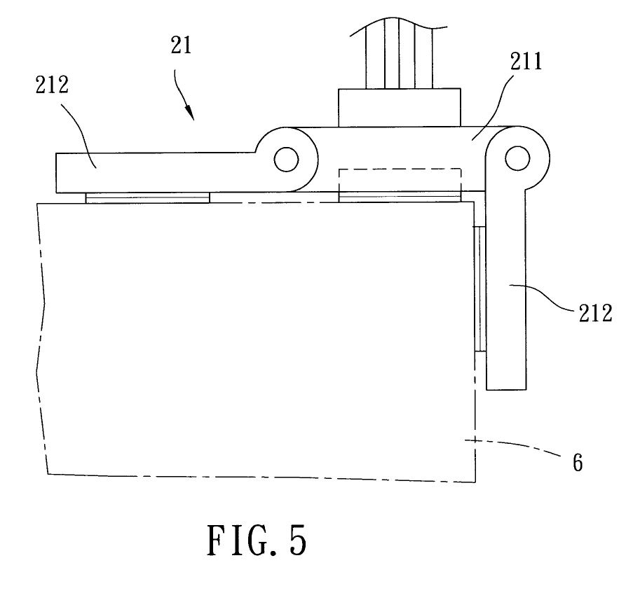

Referring to FIG. 5, when the base member 21 of the mounting device 2 is attached to a corner of the sound source 6, the base member 21 has an L-shape corresponding to the corner of the sound source 6. In particular, one of the wing plate bodies 212 is pivoted downwardly relative to the main plate body 211 in order to be attached to a side of the corner. The main plate body 211 and the other wing plate body 212 are attached to another side of the corner.

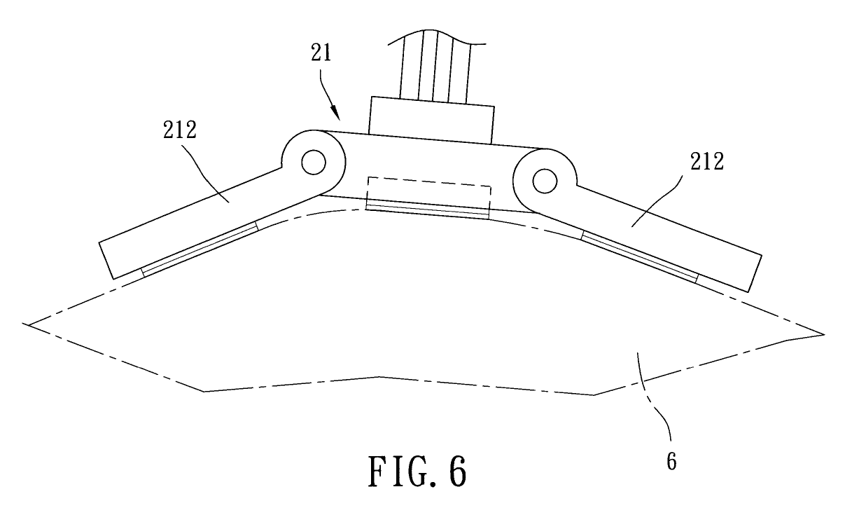

Referring to FIG. 6, when the base member 21 of the mounting device 2 is attached to a curved surface of the sound source 6,the base member 21 has a configuration corresponding to the curved surface of the sound source 6. In particular, each of the wing plate bodies 212 is pivoted downwardly relative to the main plate body 211 in order to be attached to the curved surface of the sound source 6.

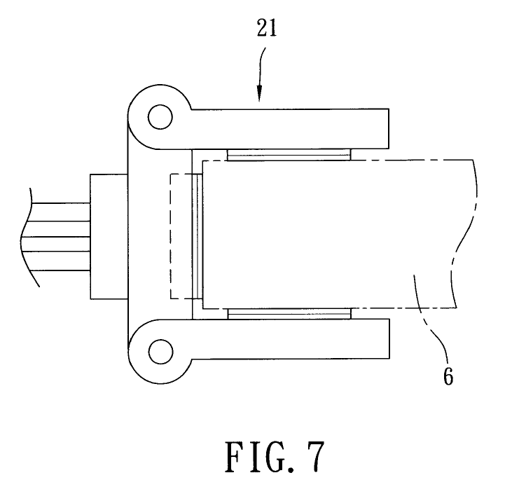

Referring to FIG. 7, when the base member 21 of the mounting device 2 is attached to a rectangular portion of the sound source 6, the base member 21 has a U-shape configuration corresponding to the rectangular portion of the sound source 6. Each of the wing plate bodies 212 is pivoted relative to the main plate body 211 in order to be attached to opposite side surfaces of the rectangular portion of the sound source 6.

Unlike the conventional sound pickup apparatus 1, the base member 21 is attached to the surface of the sound source 6 through the hook-and-loop fastening unit 22. In addition, because each of the wing plate bodies 212 is connected pivotally to the respective one of the plate connecting edges of the main plate body 211, the shape of the base member 21 can be adjusted to suit different forms of the surface of the sound source 6. Therefore, the mounting device 2 is not limited to mounting the sound pickup device 4 on a rectangular portion.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A mounting device adapted for mounting a sound pickup device on a surface of a sound source, said mounting device comprising:
a base member adapted to be connected to the sound pickup device; and
a fastening unit adapted to be provided between said base member and the surface of the sound source for positioning said base member on the surface of the sound source.

2. The mounting device as claimed in claim 1, wherein said base member includes a main plate body having at least one plate connecting edge, and at least one wing plate body connected pivotally to said plate connecting edge of said main plate body.

3. The mounting device as claimed in claim 2, wherein said main plate body has two of said plate connecting edges, and said base member includes two of said wing plate bodies, each of which is connected pivotally to a respective one of said plate connecting edges of said main plate body.

4. The mounting device as claimed in claim 3, wherein said plate connecting edges of said main plate body are opposite to each other.

5. The mounting device as claimed in claim 1, wherein said fastening unit includes at least one first fastening component provided on a surface of said base member.

6. The mounting device as claimed in claim 5, wherein said fastening unit further includes at least one second fastening component adapted to be provided on the surface of the sound source for engaging said at least one first fastening component.

7. The mounting device as claimed in claim 6, wherein one of said first and second fastening components is a hook fastening component, and the other of said first and second fastening components is a loop fastening component.

8. The mounting device as claimed in claim 2, wherein said fastening unit includes at least one first fastening component provided on a surface of at least one of said main plate body and said wing plate body of said base member, and at least one second fastening component adapted to be provided on the surface of the sound source for engaging said at least one first fastening component.

9. The mounting device as claimed in claim 8, wherein one of said first and second fastening components is a hook fastening component, and the other of said first and second fastening components is a loop fastening component.

10. The mounting device as claimed in claim 2, further comprising a support member disposed on said main plate body of said base member, and having one end opposite to said main plate body and adapted to be mounted with the sound pickup device.
